(19) United States
(12) Patent Application Publication
(10) Pub. No.: US 2026/0147752 A1
(43) Pub. Date: May 28, 2026

(54) IDENTIFYING RELEVANT DATA USING DATA EMBEDDINGS

(71) Applicant: Adobe Inc., San Jose, CA (US)

(72) Inventors: Zhenyu YAN, Cupertino, CA (US); Viswanathan Swaminathan, Saratoga, CA (US); Ritwik Sinha, Cupertino, CA (US); Deepak Pai, Sunnyvale, CA (US); Anil Kamath, Los Altos Hills, CA (US)

(21) Appl. No.: 18/957,314

(22) Filed: Nov. 22, 2024

(51) Int. Cl. G06F 16/242; G06F 16/248

(52) U.S. Cl. CPC G06F 16/242; G06F 16/248

(57) ABSTRACT

Methods, computer systems, computer storage media, and graphical user interfaces are provided for facilitating identification of relevant data using data embeddings. In one implementation, a query embedding representing a query is generated. Using the query embedding, a data embedding representing data in a hyperspace that is similar to the query embedding is identified. Thereafter, the data, represented by the data embedding identified to be similar to the query embedding, is identified as relevant to the query. Content may then be generated via one or more generative artificial intelligence (AI) models based on at least a portion of the query and the data identified as relevant to the query. Such content may be displayed via a graphical user interface.

### BACKGROUND

Various types of data are generally collected and used in various ways (e.g., analyze data, create content, etc.). For example, structured data, unstructured data, customer data, product data, social media data, public domain data, business data, etc., may be collected and accessible to use in various manners. By way of example only, such data may be used to enhance a prompt for an Artificial Intelligence (AI) technology, such as a Large Language Model (LLM), in an effort to obtain desired information in response to the prompt. For instance, in the context of content generation in association with a campaign, relevant data may be desired to be identified and included in a prompt along with a user input to facilitate creation of effective content for the campaign (e.g., an on-brand, personalized, and/or performant content). Determining or selecting specific data, for example to add context to a prompt for content generation, however, is oftentimes difficult and tedious.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for, among other things, facilitating identification of relevant data using data embeddings. In embodiments, the identification of relevant data, based on matching embeddings representing data to an embedding representing a query, is used to generate content (e.g., associated with a campaign) via AI (e.g., generative AI), such as a large language model(s) (LLM), a large vision model(s) (LVM), and/or a multimodal large language model(s) (MLLM). Among other things, embodiments described herein effectively and efficiently identify relevant data in an automated manner using a set of data embeddings. In this regard, data embeddings may be generated for various types of data that may be relevant to a query. In accordance with obtaining a query, an embedding representing the query may be generated and compared with the various embeddings representing the data. The data embeddings identified as matching or similar to the query embedding may be used to identify data relevant to the query. In this regard, the actual data and/or metadata associated with the matching data embeddings may be identified as relevant data.

In accordance with identifying data relevant to the query, the identified relevant data may be used to generate content. In particular, the identified relevant data, or an indication thereof, may be included in a prompt generated to provide as input into an AI model and obtain, in response, a generated content in association therewith. In this regard, content may be efficiently and effectively generated in association with a desired or target result (e.g., as indicated in a query). In particular, various data identified as being relevant to a query (e.g., a goal of a campaign or content) may be used, via AI technology, to generate suitable content. The resulting content may be analyzed or used (e.g., in association with a campaign). As relevant data is identified effectively and efficiently and used in conjunction with AI technology, the generation of content is performed efficiently, thereby reducing the computing resource utilization that would otherwise be used to iteratively generate content to obtain a desired content and/or perform testing of various content over an extensive testing period.

### BRIEF DESCRIPTION OF THE DRAWINGS

The technology described herein is described in detail below with reference to the attached drawing figures, wherein:

FIG. 1 is a block diagram of an exemplary system for identifying relevant data using data embeddings, suitable for use in implementing aspects of the technology described herein;

FIG. 2 is an example implementation for facilitating identification of relevant data using data embeddings, in accordance with aspects of the technology described herein;

FIG. 3 provides an example method for facilitating identification of relevant data using data embeddings, in accordance with embodiments described herein;

FIG. 4 provides another example method for facilitating identification of relevant data using data embeddings, in accordance with embodiments described herein;

FIG. 5 provides another example method for facilitating identification of relevant data using data embeddings, in accordance with embodiments described herein; and

FIG. 6 is a block diagram of an exemplary computing environment suitable for use in implementing aspects of the technology described herein.

### DETAILED DESCRIPTION

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

Different types of data are generally collected and used for various purposes. For example, structured data, unstructured data, customer data, product data, social media data, public domain data, business data, customer data, etc., may be collected and/or accessible to use in various manners. By way of example only, such data may be used to enhance a prompt for an AI model, such as an LLM, in an effort to obtain desired information in response to the prompt (e.g., on-brand, personalized, and/or performance data). For instance, in the context of content generation in association with a campaign, data may be included in a prompt as contextual data to a user input to facilitate creation of effective content for the campaign. Determining or selecting specific data, for example to add context to a prompt for content generation, however, is oftentimes difficult and tedious.

In conventional implementations, to determine data to include in a prompt to facilitate content generation, such data is generally manually selected by a user providing input or a query for the prompt. For example, a user may attempt to identify and/or select data to include in a prompt based on data that might be personalized for a particular audience segment, performant in association with a goal, resonates with the particular audience segment, etc. As the amount of data to consider is extensive, selecting valuable data may be difficult. For example, multiple sources of data may be available, but a user may select a particular source that is less suited for generating an effective content. As another example, a user may select overlapping data from different data sources, resulting in redundancies and/or ambiguities among the data. As yet another example, a user may miss a particular data source or data set altogether such that data that may be valuable in generating content is not used to do so. Further, data that may be considered valuable to a user may not result in generation of valuable content, may be outdated, or may not be well-suited for a particular audience. In some conventional implementations, heuristics may be used for data selection. Utilizing heuristics, however, may result in bias, over-simplification, staleness, and ineffective adaptation, among other drawbacks.

Accordingly, manually selecting data and/or using heuristics to select data may result in less effective content generation. As such, unnecessary computing resources are utilized to generate undesired or underperforming content. For example, computing and network resources are unnecessarily consumed in an effort to facilitate content generation based on less effective data, such as data that does not result in content personalized for a particular audience segment, performant in association with a goal, and/or resonating with the particular audience segment. In particular, computing resources may be used to generate the content. The content may then be evaluated or analyzed for effectiveness. In some cases, such evaluation or analysis may require testing the content, which also consumes various computing resources. In cases in which the content is determined to be unsuitable, the process may be iterated on to generate new content. Any number of iterations of generating content may be performed, with each iteration utilizing computing resources. For instance, computer input/output operations are unnecessarily increased in order to initiate multiple variations of content and, further, to test or evaluate the content over an extended amount of time in order to evaluate success of the different content. Further, as content is communicated over a network for various testing implementations, initiating multiple content assessments over an extended period of time to obtain feedback on the corresponding content decreases the throughput for the network, increases the network latency, and increases packet generation costs. Additionally, analyzing the feedback in relation to the multiple content variations unnecessarily consumes computing resources. For example, the feedback results must be stored for the duration of the test period for many different campaign variations. As another example, the feedback results may be manually analyzed and/or analyzed throughout the duration of the test period, thereby unnecessarily consuming computing and network resources.

As such, embodiments described herein are directed to facilitating identification of relevant data using data embeddings. In embodiments, the identification of relevant data, based on matching embeddings representing data to an embedding representing a query, is used to generate content (e.g., associated with a campaign) via AI (e.g., generative AI), such as a large language model(s) (LLM), a large vision model(s) (LVM), and/or a multimodal large language model(s) (MLLM). Among other things, embodiments described herein effectively and efficiently identify relevant data in an automated manner using a set of data embeddings. In this regard, data embeddings may be generated for various types of data that may be relevant to a query. In accordance with obtaining a query, an embedding representing the query may be generated and compared with the various embeddings representing the data. The data embeddings identified as matching or similar to the query embeddings may be used to identify data relevant to the query. In this regard, the actual data and/or metadata associated with the matching embeddings may be identified as relevant data. In accordance with identifying data relevant to the query, the identified relevant data may be used to generate content. In particular, the identified relevant data, or an indication thereof, may be included in a prompt generated to provide as input into an AI model and obtain, in response, a generated content in association therewith. In this regard, content may be efficiently and effectively generated in association with a desired or target result (e.g., as indicated in a query). In particular, various data identified as being relevant to a query (e.g., a goal of a campaign or content) may be used, via AI technology, to generate suitable content. The resulting content may be analyzed or used (e.g., in association with a campaign). As relevant data is identified effectively and efficiently and used in conjunction with AI technology, the generation of content is performed efficiently, thereby reducing the computing resource utilization that would otherwise be used to iteratively generate content to obtain a desired content and/or perform testing of various content over an extensive testing period.

At a high level, a query or query data is obtained. For example, a user may provide a query that is obtained at a content generation manager. Thereafter, a query embedding is generated to represent the query. The query embedding can be compared to a set of data embeddings in a hyperspace. Generally, data embeddings may be generated for various types of data in any number of ways and stored for querying. In accordance with identifying one or more data embeddings that match or are similar to the query embedding, the corresponding data and/or metadata may be identified as being relevant to the query. In accordance with identifying a set of data deemed relevant to a query, the identified data may be included, or referenced, in a prompt for use in generating content. For example, the identified relevant data may be included in a prompt that is input to an AI model, such as an LLM, to generate content. As the prompt includes, or references, the identified data relevant to the query, the generated content is more suited or relevant to the input query.

Advantageously, relevant data may be identified in an efficient and effective manner, resulting in generation of a more appropriate or suitable content. For example, the generated content may align more closely with the intent or desires expressed in the input query. As such, a more accurate and timely approach can be used to generate content and, moreover, result in content that is more effective and valuable. In addition, embodiments described herein provide an enhanced and intuitive user experience. In particular, in accordance with providing a query, the user is presented with helpful and accurate content. In this way, suitable campaign content is generated in a timely manner and may be more efficiently implemented to achieve designated goals.

Advantageously, efficiencies of computing and network resources can be enhanced using implementations described herein. In particular, using data embeddings to identify relevant data for use in association with AI technology to generate content provides for a more efficient use of computing resources (e.g., less computationally expensive, less input/output operations, higher throughput and reduced latency for a network, less packet generation costs, etc.) than conventional methods that may result in an extensive duration for testing and/or a manual analysis of various generated content, which is exacerbated with the extensive amount of content that can be created using AI technology. As more effective content generation is performed, unnecessary computing resources used to initiate and analyze multiple content variations is reduced. Further, the technology described herein conserves network resources, as content need not be served to an extensive number of individuals over a lengthy duration of time to evaluate the content, which results in higher throughput, reduced latency and less packet generation costs as fewer packets are sent over the network. Moreover, the technology described herein enables identification of relevant data using a set of data embeddings in an efficient and effective manner, thereby resulting in a more effective content generation via an AI model. Using a set of data embeddings enables a more computing resource-efficient implementation for identifying relevant data. For example, embeddings transform data into high-dimensional vectors that capture essential features in a compact form, thereby reducing complexity of data and resulting in a more computing-efficient process. As another example, similarity searches performed using mathematical operations on vectors are computationally less intensive than processing raw data, particularly for large datasets.

Various terms are used throughout the description of embodiments provided herein. A brief overview of such terms and phrases is provided here for ease of understanding, but more details of these terms and phrases are provided throughout.

A campaign generally refers to a plan or set of actions and messages designed to achieve a particular goal or objective. In embodiments, the goal may be related to a financial or marketing goal, such as raising awareness, promoting a product or service, increasing sales, encouraging a particular behavior or outcome, etc. Campaign data includes any associated with a campaign. Such campaign data may be captured in a campaign brief that describes the campaign. Examples of campaign data include a goal(s), a target audience(s), a message(s), a channel(s), a tactic(s), a measurement(s), a campaign asset(s), etc. A goal generally refers to a main purpose or objective associated with the campaign. A target audience generally refers to a particular group or segment of individuals the campaign is intended to reach. A target audience may be defined by any attribute, such as demographics, interests, behaviors, needs, etc. A message may refer to an idea or value the campaign communicates to inspire or encourage action or interest by an audience member. A channel generally refers to a platform or medium used to deliver a campaign asset(s) (e.g., social media, email, television, print, etc.). A tactic may include specific actions or variations that make up a campaign. A measurement may include a metric or key performance indicator used to track the success of a campaign or campaign asset.

Content generally refers to any content that may be generated. Content may be in the form of text, images, video, audio, etc. For example, content may be in the form of articles, blog posts, books, social media updates, emails, images, infographics, videos, illustrations, podcasts, music, audiobooks, etc. In some cases, content is or includes campaign content, which may be any content or material related to a campaign. Generally, campaign content may include material or messaging provided to an audience or individuals to engage, persuade, and/or encourage an action. Examples of campaign content include messages, slogans, visual branding (e.g., logos, colors, fonts, etc.), advertisements (e.g., commercials, videos, online advertisements, printed materials, images, etc.), storytelling content, social media content (e.g., blog posts, articles, etc.), videos, text, images, etc.

Query data generally refers to any data associated with a query. In this way, query data may include the query, or portions thereof, or metadata associated therewith. Query data may include, for example, a goal, a target audience segment or attributes, a company identity, a brand identity, a product identity, data associated therewith, and/or the like. In embodiments, query data may be in the form of campaign data, as described herein.

A query embedding generally refers to an embedding of a query or query data represented in a high-dimensional vector representation. Query embeddings may be generated for any type of query or query data. For example, in some cases, query embeddings are generated for data that may be used to request generation of content, such as campaign content (e.g., advertisements, emails, images, text, videos, etc.).

A data embedding generally refers to an embedding of a data represented in a high-dimensional vector representation. Data embeddings may be generated for any type of data. In some embodiments, data embeddings are generated for any type of data that may be used to identify data relevant to a query. For example, in some cases, data embeddings are generated for data that may be used to facilitate generation of content, such as campaign content (e.g., advertisements, emails, images, text, videos, etc.).

A hyperspace may be a high-dimensional space where similar embeddings are positioned close to each other, and dissimilar embeddings are positioned further apart. Such positioning enables a more efficient retrieval and matching of relevant data based on their embeddings. In some cases, each dimension in a hyperspace represents a different feature or aspect of the data. In some embodiments, the hyperspace may correspond with a particular domain, such as, for example, campaigns or content generation.

Customer data generally refers to any data regarding a customer or customers. Customer data within a dataset may include, by way of example and not limitation, data that is sensed or determined from one or more sensors, such as location information of mobile device(s), smartphone data (such as phone state, charging data, date/time, or other information derived from a smartphone), activity information (for example: app usage; online activity; searches; browsing certain types of webpages; listening to music; taking pictures; voice data such as automatic speech recognition; activity logs; communications data including calls, texts, instant messages, and emails; website posts; and other user data associated with communication events) including activity that occurs over more than one device, user history, session logs, application data, contacts data, calendar and schedule data, notification data, social network data, news (including popular or trending items on search engines or social networks), online gaming data, ecommerce activity, including customer journey data, sports data, health data, customer demographics, customer's geographical location, economic status, customer gender, customer age, or any other relevant demographic data collected regarding the customer, and nearly any other source of data that may be used to identify the customer.

### Overview of Exemplary Environments for Facilitating Identification of Relevant Data Using Data Embeddings

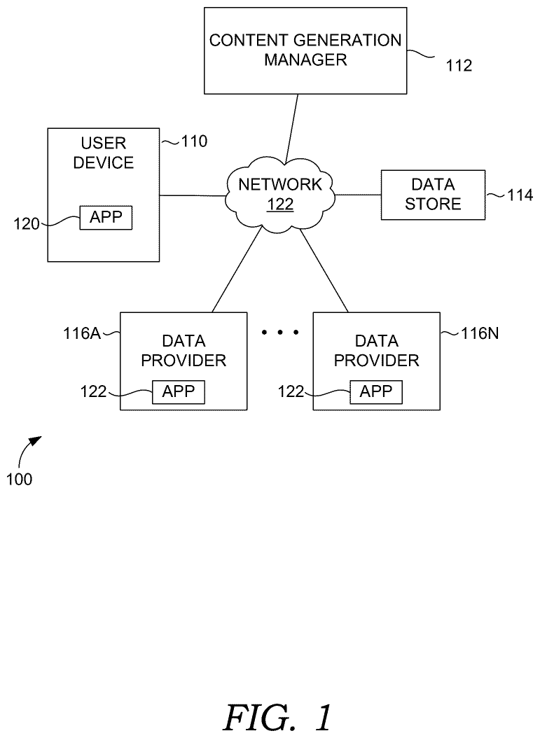

Referring initially to FIG. 1, a block diagram of an exemplary network environment 100 suitable for use in implementing embodiments described herein is shown. Generally, the system 100 illustrates an environment suitable for facilitating identification of relevant data using data embeddings. In embodiments, the identification of relevant data, based on embedding matching, is used to generate content (e.g., associated with a campaign) via AI (e.g., an LLM, LVM, and/or MLLM). Among other things, embodiments described herein effectively and efficiently identify relevant data based on matching one or more data embeddings that represent data with a query embedding that represents a query. Thereafter, the identified relevant data may be used to generate content. In particular, the identified relevant data, or an indication thereof, may be included in a prompt generated to provide as input into an AI model and obtain, in response, a generated content in association therewith. In this regard, content may be efficiently and effectively generated in association with a desired or target result (e.g., as indicated in a query). In particular, various data identified as being relevant to a query (e.g., a goal of a campaign or content) may be used, via AI technology, to generate suitable content. The resulting content may be analyzed or used (e.g., in association with a campaign). As relevant data is identified effectively and efficiently and used in conjunction with AI technology, the generation of content is performed efficiently, thereby reducing the computing resource utilization that would otherwise be used to iteratively generate content to obtain a desired content and/or perform testing of various content over an extensive testing period.

In operation, a user, such as a marketer, can input or provide a query or query data and, based on the input, be automatically provided with one or more generated content items related to the query. In embodiments, query data may include a goal, a target audience segment or attributes, a company identity, a brand identity, a product identity, data associated therewith, and/or the like. The resulting generated content may be generated in a manner that is suitable to attain a desired performance or effectiveness of the content (e.g., in association with a campaign goal). As described herein, various data may be identified as being relevant to a query and used to generate the content. In this regard, the AI technology can more effectively generate content using the supplemental data identified as relevant to the query.

The network environment 100 incorporates the identification of relevant data in an environment or system that generates content using AI technology. In FIG. 1, the network environment includes a user device 110, a content generation manager 112, a data store 114, and data providers 116a-116n (referred to generally as data source [s] 116). The user device 110, the content generation manager 112, the data store 114, and the data providers 116a-116n can communicate through a network 122, which may include any number of networks such as, for example, a local area network (LAN), a wide area network (WAN), the Internet, a cellular network, a peer-to-peer (P2P) network, a mobile network, or a combination of networks.

The network environment 100 shown in FIG. 1 is an example of one suitable network environment and is not intended to suggest any limitation as to the scope of use or functionality of embodiments disclosed throughout this document, and nor should the exemplary network environment 100 be interpreted as having any dependency or requirement related to any single component or combination of components illustrated therein. For example, the user device 110 and data providers 116a-116n may be in communication with the content generation manager 112 via a mobile network or the Internet, and the content generation manager 112 may be in communication with data store 114 via a local area network. Further, although the environment 100 is illustrated with a network, one or more of the components may directly communicate with one another, for example, via HDMI (high-definition multimedia interface) and DVI (digital visual interface). Alternatively, one or more components may be integrated with one another; for example, at least a portion of the content generation manager 112 and/or data store 114 may be integrated with the user device 110 and/or data providers 116. For instance, a portion of the content generation manager 112 may be integrated with a server in communication with a user device 110 and/or data providers 116, while another portion of the content generation manager 112 may be integrated with the user device 110 and/or data providers 116.

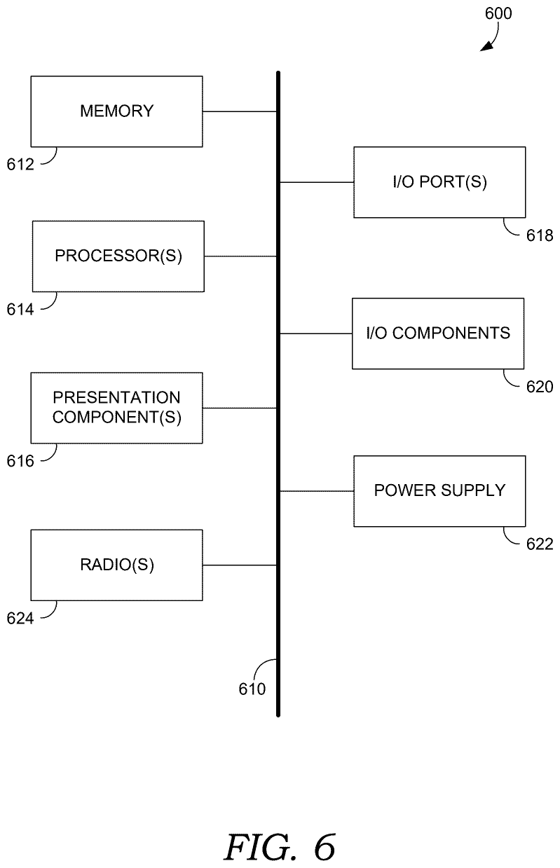

The user device 110 and the data providers 116 can be any kind of computing device capable of facilitating management of identifying relevant data using data embeddings. For example, in an embodiment, the user device 110 and/or data providers 116 can be a computing device such as computing device 600, as described above with reference to FIG. 6. In embodiments, the user device 110 and/or data providers 116 can be a personal computer (PC), a laptop computer, a workstation, a mobile computing device, a personal digital assistant (PDA), a cell phone, or the like. Although illustrated separately, in some cases, the functionality described in association with the user device 110 and the data providers 116 may be performed via a single device (e.g., the user device also provides the query [s]).

The user device 110 and/or the data providers 116 can include one or more processors and one or more computer-readable media. The computer-readable media may include computer-readable instructions executable by the one or more processors. The instructions may be embodied by one or more applications, such as application 120 and/or application 122 shown in FIG. 1. The application(s) may generally be any application capable of facilitating identification of relevant data using data embeddings. In some cases, the application(s), such as application 120, may facilitate providing query data, for example in association with a campaign. In some cases, the query data may be provided in the form of a query. In some implementations, the application(s) comprises a web application, which can run in a web browser, and could be hosted at least partially server-side (e.g., via content generation manager 112). In addition, or instead, the application(s) can comprise a dedicated application. In some cases, the application is integrated into the operating system (e.g., as a service). As one specific example application, application 120 may be a content management tool and/or analytics tool (e.g., Adobe® Experience Manager or Adobe® Analytics), or a portion thereof, that enables creation, management, delivery, and/or analysis of content and digital assets. In some cases, such digital experiences may be provided across various channels, such as websites, mobile apps, forms, electronic communications, etc. Application 120 and/or 122 may be accessed via a mobile application, a web application, or the like. Application 120 and 122 may be the same application or different applications.

User device 110 and/or data provider 116 can be a client device on a client-side of operating environment 100, while content generation manager 112 can be on a server-side of operating environment 100. Content generation manager 112 may comprise server-side software designed to work in conjunction with client-side software on user device 110 and/or data provider 116 so as to implement any combination of the features and functionalities discussed in the present disclosure. An example of such client-side software is application 120 on user device 110. Alternatively, the user device 110 and/or the data provider 116 may include server-side software. For example, the data provider may be a third-party data provider that provides data via a server. As another example, the data provider may operate in coordination with the content generation manager on the service side to access or use various types of data (e.g., some data of which may be proprietary data and some data of which may be third-party data). This division of operating environment 100 is provided to illustrate one example of a suitable environment, and it is noted that there is no requirement for each implementation that any combination of user device 110, content generation manager 112, and/or data provider 116 to remain as separate entities.

In an embodiment, the user device 110 and/or data provider 116 is separate and distinct from the content generation manager 112 and the data store 114 illustrated in FIG. 1. In another embodiment, the user device 110 and/or data provider 116 is integrated with one or more illustrated components. For instance, the user device 110 and/or data provider 116 may incorporate functionality described in relation to the content generation manager 112. For clarity of explanation, embodiments are described herein in which the user device 110, the content generation manager 112, the data store 114, and the data providers 116 are separate, while understanding that this may not be the case in various configurations contemplated.

As described, a user device, such as user device 110, can facilitate providing a query or query data to content generation manager 112 and, in response, view content generated in association with the query. Advantageously, the content is generated using additional data identified as being relevant to the query, such that the content is more aligned or suitable in relation to the query. A user device 110, as described herein, may be operated by an individual or set of individuals that desires to view content, for example, generated for a campaign. As one example, a user device may be operated by a campaign manager or marketing manager. Such an individual may be affiliated with or a representative of a company associated with the campaign.

In some cases, generation of content in association with a campaign(s) may be initiated at the user device 110. For example, a user, such as an administrator or campaign manager, may input, provide, or select a query or query data. For instance, a user may input or select, via a user interface, a query associated with a campaign. In some cases, a user may provide a goal, an objective, a target audience, a target channel, a content type, etc., and/or an indication thereof. Such data may be provided via a text input box. In other cases, such data may be provided as a campaign brief including various campaign data for a campaign. For example, a user may select to upload a campaign brief document. The query data may include any type of data associated with a desired content and/or campaign. Any number and combination of various query data may be included. For example, a first set of query data provided via user device 110 for a first campaign content may include a goal and a target audience, while a second query provided via user device 110 for a second campaign content may include a goal and a product description. As can be appreciated, in some cases, an administrator, programmer, manager, or other individual affiliated with the campaign may input or select a set of query data to use for generating content.

Although only a single user device 110 is illustrated in FIG. 1, any number of user devices may operate in this environment. For example, a first user device may provide a first query in association with a first campaign, while a second user device may provide a second query in association with a second campaign.

An input or selection of a query or query data can be provided via an application 120 operating on the user device 110. In this regard, the user device 110, via an application 120, might allow a user (e.g., an administrator) to input, select, or otherwise provide a set of query data. The application 120 may facilitate the inputting of query data in a verbal form, a textual input form, a document form, etc. Such query data may be input at the user device 110 in any manner. For instance, upon accessing a particular application (e.g., a content management application), a user may be presented with, or navigate to, an input tool to input a query (e.g., via text input). As another example, a user may navigate to and select a document that includes campaign data for a query.

The user device 110 can communicate with the content generation manager 112 to provide the query or query data and/or request generation of a content item(s). In embodiments, for example, a user may utilize the user device 110 to provide a query via the network 122. For instance, in some embodiments, the network 122 might be the Internet, and the user device 110 interacts with the content generation manager 112 to provide a query for use in generating content. In other embodiments, for example, the network 122 might be an enterprise network associated with an organization. It should be apparent to those having skill in the relevant arts that any number of other implementation scenarios may be possible as well.

The data providers 116 are generally configured to provide data for use by the content generation manager 112, for example, to generate content. As described, a data provider may provide any type of data. In some cases, a data provider may provide data from a particular data source. Such a data source may include proprietary data and/or third-party data. For example, product details may be proprietary data provided by data provider 116A, while data provider 116N may provide third-party social media data. Any number of data providers may operate in this environment. For example, a first data provider may provide a first set of data, while a second data provider may provide a second set of data. In embodiments, the data may be provided to the data store 114 such that the data store 114 collects the data for reference or use by the content generation manager 112.

The data providers 116 can communicate with the content generation manager 112, data store 114, or other component to provide data. In embodiments, for example, the network 122 might be the Internet, and the data provider 116 interacts with the content generation manager 112 and/or data store 114 to provide various types of data for use in, among other things, generating content. In other embodiments, for example, the network 122 might be an enterprise network associated with an organization. It should be apparent to those having skill in the relevant arts that any number of other implementation scenarios may be possible as well.

With continued reference to FIG. 1, the content generation manager 112 can be implemented as server systems, program modules, virtual machines, components of a server or servers, networks, and the like. At a high level, the content generation manager 112 manages generation of content in accordance with data identified as being relevant to a query. In operation, and at a high level, the content generation manager 112 can obtain a query, for example, associated with a campaign from user device 110. Based on the query, relevant data is identified using data embeddings. In particular, data embeddings are generated in a hyperspace for various types and amounts of data. In accordance with obtaining a query or query data, a query embedding may be generated to represent the query. The query embedding can then be compared to the data embeddings to identify data embeddings in the hyperspace that match, or are similar to, the query embedding. Thereafter, the actual data and/or corresponding metadata associated with the identified data embeddings may be identified as relevant data to the query. In accordance with identifying relevant data, the relevant data may be used, or referenced, in generating a prompt to initiate generation of content in association therewith. Using AI models, such as an LLM, LVM, and/or MLLM, content may be generated based on the data identified as relevant to the query. As such, the content is generated in a manner to provide an effective content in association with a campaign. In some cases, the content may then be presented and/or used to present results via a user interface, for example, of the user device 110. Such content can additionally or alternatively be transmitted to data store 114 for access by any component managing or executing a campaign. Advantageously, utilizing implementations described herein enables generation of content to be performed in an efficient and accurate manner in accordance with data efficiently identified as being relevant to a query.

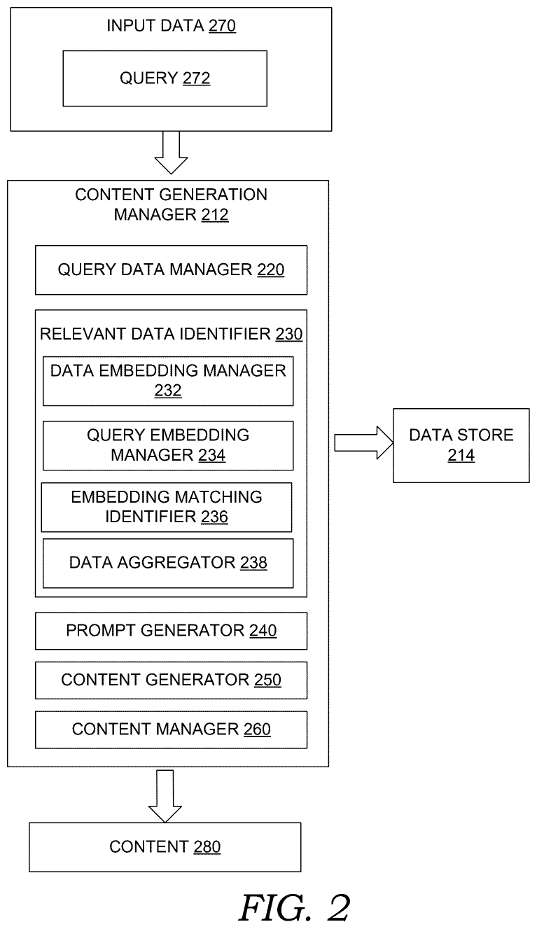

Turning now to FIG. 2, FIG. 2 illustrates an example implementation for facilitating content generation based on identifying relevant data using data embeddings. The content generation manager 212 can communicate with the data store 214. The data store 214 is configured to store various types of information accessible by the content generation manager 212, or other server or component. In embodiments, user device (such as user device 110 of FIG. 1), data sources (such as data sources 116 of FIG. 1), and content generation manager 212 can provide data to the data store 214 for storage, which may be retrieved or referenced by any such component. As such, the data store 214 may store queries, query embeddings, data embeddings, data, metadata, and/or the like.

In operation, the content generation manager 212 is generally configured to facilitate or manage generation of content (e.g., in association with a campaign) using data identified as relevant based on embedding matching. In particular, the content generation manager 212 manages generation of content using data identified as being relevant to a query, wherein the relevant data is identified by matching a set of embeddings that represent data with an embedding that represents a query. In this way, content may be generated in an efficient and effective manner. In embodiments, the content generation manager 212 includes a query data manager 220, a relevant data identifier 230, a prompt generator 240, a content generator 250, and a content manager 260. According to embodiments described herein, the content generation manager 212 can include any number of other components not illustrated. In some embodiments, one or more of the illustrated components 220, 230, 240, 250, and 260 can be integrated into a single component or can be divided into a number of different components. Components 220, 230, 240, 250, and 260 can be implemented on any number of machines and can be integrated, as desired, with any number of other functionalities or services.

The query data manager 220 is generally configured to manage query data that is used to search for data. Query data generally refers to any data associated with a query. In this way, query data may include a portion (e.g., text) of a query, or metadata or data associated therewith. A query generally refers to a request for information or data. In one embodiment, a query or query data is used to generate a prompt. In some cases, a query may be input by a user, for example, via a text input box. In this regard, the query data manager 220 may obtain a query 272 as input data 270. As described, in some embodiments, a query may be obtained via a user, such as user device 110 of FIG. 1. In this regard, a user may provide a query via a user interface of the user device, which then provides the query to the content generation manager 212 (e.g., via a network). In some cases, a query may be input, uploaded, or selected via a user interface. Alternatively or additionally, a query may be computer generated, for example, to perform data analysis or in response to performing data analysis. In this way, a computer may generate a query and provide the query to the content generation manager (e.g., via a network).

Initially, the query data manager 220 obtains query data. Query data may be obtained in any number of ways. In some cases, as described, a query may be obtained by a user device, such as user device 110 of FIG. 1. In other cases, a query may be obtained from a data store, such as data store 214, or other computing device.

In some embodiments, query data may include data associated with a campaign or content to be generated. A campaign generally refers to a plan or set of actions and messages designed to achieve a particular goal or objective. Content generally refers to any content that may be generated. In some cases, content is or includes campaign content and may be any content or material related to a campaign. Generally, campaign content may include material or messaging provided to an audience or individuals to engage, persuade, and/or encourage an action. Content, such as campaign content, may take on any of a number of forms. In embodiments, content is in the form of a content item, such as an image and/or text, that conveys or portrays a message, product, item, etc. Examples of content include messages, slogans, visual branding (e.g., logos, colors, fonts, etc.), advertisements (e.g., commercials, videos, online advertisements, printed materials, images, etc.), storytelling content, social media content (e.g., blog posts, articles, etc.), videos, text, images, etc.

In cases in which query data reflects a campaign, or a portion thereof, query data may include any data that indicates a goal, a target audience, a message, a channel, a tactic, a measurement, a timing, a messaging tone, etc., associated with a campaign and/or campaign content. A goal may refer to any goal or objective associated with a campaign and/or a campaign content(s). Examples of goals may include increasing sales for a particular product, retaining customers, encouraging product use to increase opportunities for renewing subscriptions, etc. A target audience generally refers to a particular group or segment of individuals the campaign is intended to reach. A target audience may be defined by any attribute, such as demographics, interests, behaviors, needs, etc. A message may refer to an idea or value the campaign communicates to inspire or encourage action or interest by an audience member. A channel generally refers to a platform or medium used to deliver a campaign asset(s) (e.g., social media, email, television, print, etc.). A tactic may include specific actions or variations that make up a campaign. A measurement may include a metric or key performance indicator used to track the success of a campaign or campaign asset. A timing may indicate when campaign assets are to be delivered to audience members. A messaging tone refers generally to the tone of the message or campaign content.

In embodiments, the query data manager 220 processes the query data. In this regard, the query data manager 220 may parse the query to break down the query to constituent parts to understand its structure and meaning. For example, parsing a query may enable identification of key elements such as the main subject, any specific details, and the type of information or response being requested. In association with parsing, key terms or elements may be identified or extracted. For instance, the subject, specific details, and/or desired format of response may be identified. The context of the query may also be considered. For example, implicit information based on previous interactions or general knowledge about a topic may be identified.

Upon parsing and identifying elements, the query or query data may be optimized in various manners. For example, redundancies may be identified and removed. As another example, expressions may be simplified. In this way, more complex phrases may be reduced to simpler, more direct expressions. As another example, focus may be on key elements. As such, extraneous information that does not contribute to the core request or request intent may be removed. As yet another example, components of the query may be rephrased for clarity and/or ambiguities removed. The resulting query data may be used to perform or execute a request for information. For example, the query data may be used to facilitate generation of a prompt to input to an AI model, such as an LLM, for instance to generate content (e.g., in association with a campaign).

The relevant data identifier 230 is generally configured to identify relevant data. In particular, in embodiments, the relevant data identifier 230 may identify data relevant to the query data. Relevant data may be identified for any number of reasons. As one example, relevant data may be identified to use in a prompt input to an AI model, such as an LLM. For instance, relevant data may be identified to include in a prompt as context data for generating content (e.g., in association with a campaign) via AI technology or performing another task associated with AI technology. Although many examples provided herein include using data identified as relevant in association with a prompt to input to an AI model, relevant data may be identified for any number of use cases. For example, relevant data may be identified for training an AI model or for performing analysis of such data.

In embodiments, to identify relevant data, the relevant data identifier 230 may match a query embedding to data embeddings in a hyperspace. In this regard, embedding matching may be used to identify relevant data, for example, for use in generating a prompt to initiate content generation via AI. At a high level, embedding matching includes matching a query embedding that represents a query against data embeddings representing data in a hyperspace to identify relevant data.

To identify relevant data using embedding matching, the relevant data identifier 230 may include, in embodiments, a data embedding manager 232, a query embedding manager 234, an embedding matching identifier 236, and a data aggregator 238. According to embodiments described herein, the content generation manager 212 can include any number of other components not illustrated. In some embodiments, one or more of the illustrated components 232, 234, 236, and 238 can be integrated into a single component or can be divided into a number of different components. Components 232, 234, 236, and 238 can be implemented on any number of machines and can be integrated, as desired, with any number of other functionalities or services.

The data embedding manager 232 is generally configured to manage data embedding. In embodiments, the data embedding manager 232 generates data embeddings and places in a hyperspace in which various types of data are embedded. An embedding generally refers to a high-dimensional vector representation. Such an embedding or high-dimensional vector representation represents or captures the semantic meaning and relationships between data points. Stated differently, the embedding or high-dimensional vector representation captures essential features and relationships of data in a numerical form that can be processed, for example, by a machine learning model. An embedding captures unique characteristics of each data item, thereby allowing for precise matching and retrieval.

A data embedding generally refers to an embedding of a data represented in a high-dimensional vector representation. Data embeddings may be generated for any type of data. In some embodiments, data embeddings are generated for any type of data that may be used to identify data relevant to a query. For example, in some cases, data embeddings are generated for data that may be used to facilitate generation of content, such as campaign content (e.g., advertisements, emails, images, text, videos, etc.).

Examples of such data for which embeddings are generated include product data, engagement metrics, target audience attributes, organization data, brand data, events, customer data, social media data, and/or the like. Product data may relate to any data in association with a product. For example, product data may include price, product type, product features, product benefits, product availability, etc. Engagement metrics generally refers to any metrics indicating engagement with a product or brand (e.g., clicks, user interactions, feedback, purchases, etc.). Target audience attributes generally refers to attributes associated with a target audience. Such target audience attributes may include demographics (e.g., age, gender, location, etc.), interests, preferences, behaviors (e.g., new customers, returning customers, etc.), and/or the like. Organization data generally refers to any data associated with an organization. In some cases, organization data may include an organization identifier identifying or indicating an organization. Brand data generally refers to any data associated with a brand, such as a brand identity, brand features, brand values, etc. Events generally refer to occurrences of actions that may involve entities and have significance in the domain. Customer data generally refers to any data associated with customers (e.g., of a brand, product, company, etc.). Social media data generally refers to any data associated with a social media platform. Examples of social media data include posts, such as photos, videos, or stories; tags used to categorize posts; comments; users; reactions; reshares; etc.

Such data may be stored in association with various data sources. Examples of data sources that may include or provide data include product databases, internal documentation, marketing materials, customer relationship management (CRM) systems, surveys and feedback, behavioral data, analytics platforms, etc. Product features generally refer to information about product features, which is often stored in product databases or product information management (PIM) systems. Such databases may contain detailed descriptions, specifications, and updates about the products. Internal documents, such as product manuals, feature lists, and development notes, may provide comprehensive details about the features of each product. Marketing materials may include brochures, product pages on the company's website, and marketing campaigns that describe product features and benefits. CRM systems may store detailed information about customer preferences, purchase history, and interactions with the company. Customer surveys, feedback forms, and reviews provide direct insights into user preferences and satisfaction levels. Behavioral data may reflect data collected from user interactions with the company's website, mobile apps, and other digital platforms, which may reveal preferences based on browsing history, click patterns, and purchase behavior. Analytics platforms may track user engagement metrics such as page views, time spent on site, click-through rates, and conversion rates. Social media platforms provide engagement metrics such as likes, shares, comments, and follower growth. Email marketing tools may track metrics such as open rates, click rates, and unsubscribe rates, providing insights into how users engage with email content.

The data embedding manager 232 may obtain data to embed in any of a number of ways. In some cases, data embedding manager 232 may obtain data for which to generate embeddings. For example, a data source(s) and/or data store(s) may be configured to provide data on a periodic basis or upon an occurrence of an event. For instance, data may be obtained (e.g., received, retrieved, or accessed) via a data provider, such as data providers 116 of FIG. 1. As another example, a user of a user device may provide a request that triggers the data embedding manager 232 to obtain data. For instance, based on a user request, the data embedding manager 232 may access or retrieve data from one or more data sources and/or data stores.

In accordance with obtaining data, the data embedding manager 232 may facilitate generation of data embeddings corresponding therewith. In this regard, the data embedding manager 232 may be, include, or access a model(s) to generate the data embeddings. As described herein, any number or type of model may be used to generate data embeddings. For example, in some cases, data may exist in a text format, an image format, or a combination thereof, and different models may be used to generate data embeddings in association with the different data formats. For instance, for text data, embeddings may be generated using models, such as BERT or GPT, which convert text into a high-dimensional vector space. For image data, models, such as CLIP, may be used to create embeddings for images and corresponding captions, ensuring that similar images and captions are close in the embedding space. For data that includes text and images (e.g., social media posts with images and captions), multimodal models can be used to create embeddings that capture both aspects.

The data embeddings may be generated in any number of sizes or dimensions. In some cases, the size of the embedding vector, or the number of dimensions, is determined based on the model, or embedding model, used to generate embeddings in a multidimensional vector space. For instance, the BERT model typically generates embeddings with 768 dimensions, while the CLIP model generally generates embeddings with 512 dimensions. The dimensions of the data embeddings reflect various features and characteristics of the data. Each dimension captures a different aspect of the data's meaning or content. For example, for a text embedding, dimensions may capture semantic features such as topic, sentiment, or syntactic structure. For image embeddings, dimensions may capture visual features such as color, texture, and shapes.

As described, the data is transformed into a unique vector in a hyperspace. As such, the data embedding manager 232 may facilitate positioning data embeddings in a hyperspace. In embodiments, the model used to generate data embeddings is used to position (e.g., inherently) the data embeddings in the hyperspace based on the corresponding vector values. A hyperspace may be a high-dimensional space where similar embeddings are positioned close to each other, and dissimilar embeddings are positioned further apart. Such positioning enables a more efficient retrieval and matching of relevant data based on their embeddings. In some embodiments, the hyperspace may correspond with a particular domain, such as, for example, campaigns or content generation.

A hyperspace may be of any structure or format. In embodiments, the structure of the hyperspace may be determined based on dimensions of the embeddings. For example, assume embeddings are 512-dimension vectors. In such a case, the hyperspace is a 512-dimensional space. The position of each data embedding in the hyperspace is determined by its vector values.

An embedding model(s) used to generate data embeddings and/or position data embeddings in a hyperspace may be trained to generate a model that most effectively and efficiently creates data embeddings in a hyperspace. In particular, the embedding model(s) may be trained to position embeddings in such a way that similar data embeddings are close to each other in the hyperspace and dissimilar embeddings are further apart. Training of an embedding model may include use of training data that includes pairs of similar embeddings or data points and pairs of dissimilar embeddings or data points.

A loss function may be used to facilitate the training process. Such a loss function may facilitate learning of placing similar data points close together in the embedding space. In this way, the loss function may be designed to optimize the placement of embeddings in the hyperspace. Examples of loss functions for embedding models include triplet loss and contrastive loss, although embodiments are not intended to be limited hereto. Such loss functions measure the distance between embeddings and adjust model parameters to minimize the distance between similar data points and maximize the distance between dissimilar ones. Triplet loss generally refers to a loss function that uses triplets of embeddings, such as an anchor; a positive example that is similar to the anchor; and a negative example that is dissimilar to the anchor. In triplet loss, the goal is to minimize the distance tween the anchor and the negative example. With contrastive loss, pairs of embeddings are used in an effort to minimize the distance between similar pairs and maximize the distance between dissimilar pairs.

Data embeddings may be stored, for example, in a data store, such as data store 214. Embeddings may be stored, for instance, in a database or an index that enables efficient retrieval. As one example, a vector database may be used for storing and retrieving embeddings efficiently. In some embodiments, data embeddings may be stored in association with corresponding metadata (e.g., via a relational database). Such metadata may include information associated with the embedding, such as original data (e.g., text, image, etc.), identifiers, attributes (e.g., author, category, performance metrics, date of creation, etc.), data type, source information (e.g., details about the source of the data), references or information that links the data embedding to the original data or provides additional context, etc.

The query embedding manager 234 is generally configured to manage query embeddings. In this way, the query embedding manager 234 may generate a query embedding to represent the query or query data. In embodiments, the query embedding manager 234 generates query embeddings. A query embedding generally refers to an embedding of a query or query data represented in a high-dimensional vector representation. Query embeddings may be generated for any type of query data. In some embodiments, query embeddings are generated for any type of data that may be used in a query. For example, in some cases, query embeddings are generated for data that may be used to request generation of content, such as campaign content (e.g., advertisements, emails, images, text, videos, etc.). Examples of such query data may include a goal(s), a product(s), a type of engagement metric(s), a target audience attribute(s), organization data, brand data, and/or the like.

As such, the query embedding manager 234 may obtain a query or query data to embed in any of a number of ways. In some cases, query embedding manager 234 may obtain a query or query data via a user device. In this way, a user of a user device, such as user device 110, may provide a query that is obtained at the query embedding manager 234. Alternatively or additionally, a query or query data may be obtained via the query data manager 220 and/or the data store 214.

In accordance with obtaining a query or query data, the query embedding manager 234 may facilitate generation of query embeddings corresponding therewith. In this regard, the query embedding manager 234 may be, include, or access a model(s) to generate the data embeddings. As described herein, any number or type of model may be used to generate data embeddings. In some embodiments, a same embedding model(s) may be used to generate query embeddings as the embedding model(s) used to generate data embeddings. In some cases, a query or query data may exist in a text format, an image format, or a combination thereof, and different models may be used to generate query embeddings in association with the different query formats. For instance, for text queries, embeddings may be generated using models, such as BERT or GPT, which convert text into a high-dimensional vector space. For image queries, models, such as CLIP, may be used to create embeddings for images and corresponding captions, ensuring that similar images and captions are close in the embedding space. For queries that include text and images, multimodal models can be used to create embeddings that capture both aspects.

The query embeddings may be generated in any number of sizes or dimensions. In some cases, the size of the embedding vector, or the number of dimensions, is determined based on the model, or embedding model, used to generate embeddings in a multidimensional vector space. In embodiments, the size of the query embeddings may be the same or similar as the size of query embeddings.

In some embodiments, query embeddings may be stored, for example, in a data store, such as data store 214. Data embeddings may be stored in association with corresponding metadata. Such metadata may include information associated with the embedding, such as original query or query data, identifiers, attributes, etc.

The embedding matching identifier 236 is generally configured to manage embedding matching. In this regard, the embedding matching identifier 236 may match the query embedding against data embeddings in the hyperspace to identify the most relevant data. In this regard, the data embeddings most similar to the query embedding may be used to provide relevant data, for example, for content generation.

In this way, the embedding matching identifier 236 may perform a similarity search in which the query embedding is compared against data embeddings (e.g., stored in a data store) using similarity measures to find the most relevant matches. For example, the query embedding may be used to search an index of stored data embeddings to identify data embeddings closest to or most similar to the query embedding based on a particular similarity measure. Any approach for similarity matching may be performed. In some embodiments, similarity measurements such as cosine similarity, Euclidian distance, and/or dot product may be used. Such measures generally calculate how close or far apart two embeddings are in a hyperspace. Cosine similarity measures the cosine of the angle between two vectors. Euclidean distance generally measures the straight-line distance between two points in the high-dimensional space. Dot product generally measures the magnitude of projection of one vector onto another.

In some embodiments, the embedding matching identifier 236 may initially perform a search or query process that includes querying a data store (e.g., index) to identify data embeddings likely to be similar to the query embeddings. For example, an approximate nearest neighbor search may be performed to reduce the search space to a subset of data embeddings that are most likely to be similar to the query embedding. Examples of approximate nearest neighbor search include Facebook AI similarity search, Approximate Nearest Neighbors Oh Yeah, and Hierarchical Navigable Small World. In accordance with narrowing down potential matches, similarity measures between the query embedding and such candidate data embeddings may be determined and used to select the most relevant data.

The data embeddings identified as being similar to the query embedding may be retrieved. In some cases, each data embedding identified as matching the query embedding may be retrieved. In other cases, data embeddings most similar to or matching the query embedding may be retrieved. For example, data embeddings may be identified as being similar to or matching the query embedding based on similarity scores. The most similar embeddings, or those with the highest similarity score or that exceed a similarity score threshold, may be designated as relevant data embeddings.

Based on the identification of data embeddings matching the query embedding (e.g., based on similarity analysis), such identified data embeddings may be retrieved (e.g., from the data store). In some cases, the retrieved data embeddings are ranked according to their similarity scores. In other cases, the data embeddings may be ranked prior to retrieving such data embeddings.

For data embeddings identified as most similar or matching the query embedding, the actual or associated data points and corresponding metadata may be obtained. In some cases, such data may be obtained for data embeddings ranked the highest according to their similarity scores. For instance, a set of top N ranked data embeddings may be identified and corresponding data obtained. As another example, data embeddings with a similarity score over a certain threshold value may be identified and corresponding data obtained. Using such an approach enables identification of data that is relevant to the query. In this way, data may be identified as being relevant to a query that is the most suitable data to facilitate generation of content in accordance with attributes or components included in the query (e.g., to attain a goal, for a particular audience, or other factors for a campaign).

The data and/or metadata may be obtained in any manner. As one example, in accordance with a particular data embedding, a corresponding unique identifier associated with the data may be identified, which may then be used to reference the actual data and/or metadata. For example, in accordance with storing an embedding in a vector database, a corresponding unique identifier may be stored that links the embedding to the actual data and metadata. The unique identifier may be used to query a data store (e.g., relational database) to obtain the metadata and actual data associated with the unique identifier.

The data aggregator 238 is generally configured to aggregate data identified based on performing embedding matching. As can be appreciated, embedding matching may result in identification of any number of data or types of data. For instance, a first data embedding similar to a query embedding may relate to social media data, a second data embedding similar to the query embedding may relate to product data, and a third data embedding similar to the query embedding may relate to customer data.

In some cases, the data aggregator 238 may aggregate references to or indications of the different data. In this way, the identified data may subsequently be accessed or obtained (e.g., via a prompt generator). Additionally or alternatively, the data aggregator 238 may aggregate data obtained via the embedding matching identifier 236, as described above. In some cases, the data to be aggregated or compiled may exist in association with various data sources (e.g., hosted by one or more entities). The data aggregator 238 may obtain the data (e.g., via requests, APIs, the embedding matching identifier, etc.) and aggregate the data into a set of data relevant to the query.

In some cases, the aggregated data, or indications or representations thereof, may be provided for display. For example, for a user that input a query, the data identified as being relevant to the query, or a representation thereof, may be presented via a user interface of the user device. In some implementations, the user may be provided with an option to select all or a portion of the data for utilization, for example, to generate a prompt to create content.

As described, the data identified as relevant may be used in any number of ways. In one embodiment, the relevant data is used to generate content, such as content in association with a campaign. In this way, the relevant data may be used in association with a prompt for generating content. As such, the prompt generator 240 is generally configured to generate a prompt that may be used to initiate generation of content. A prompt generally refers to an input, such as an input text and/or graphic, that can be provided to a content generator 250, such as an LLM, LVM, and/or MLLM, to generate an output in the form of content. In embodiments, the prompt can include data, such as text and/or images, or an indication or reference thereto to influence an AI model (e.g., an LLM) to generate content having a desired content and/or structure. A prompt typically includes text given to an AI model to be completed. In this regard, a prompt generally includes instructions and, in some cases, identified relevant data to use in performing the analysis. Additionally or alternatively, the prompt may include images, or other non-text data, to influence an AI model, such as an LVM and/or MLLM, to generate an output having desired content and structure.

In accordance with embodiments described herein, a prompt may include or reference various data. By way of example only, a prompt may include an instruction or request, query data, and/or data relevant to the query, or references thereto, to be analyzed. An instruction generally refers to a request for generating content (e.g., text, images, and combinations thereof) for example, in accordance with query data. For instance, a prompt may include a request to generate content based on the query data and the corresponding relevant data (e.g., included in the prompt or referenced in the prompt). In some cases, an instruction may further indicate a type of content requested. For example, the prompt may request content in the form of an email, content in the form of an advertisement for social media, etc. In some cases, such a desired or target content may be input or specified by a user, such as a user of user device 110. In other cases, a content type may be a default setting. In yet other cases, a content type may be determined, for example, in association with a goal included in query data. In embodiments, a prompt may include or reference a content item(s) to modify or use as a basis for content creation.

As described, relevant data, or an indication or representation thereof, may be included in a prompt to use in creating content (e.g., in association with a campaign). Any number or type of data may be included in a prompt. In some embodiments, the prompt generator 240 may include the relevant data aggregated by the data aggregator 238, or a portion thereof, in the prompt to generate content. For example, various social media data, product data, and customer data may be included in the prompt. In other embodiments, the prompt generator 240 may include a representation or indication of the relevant data. In this way, the indications of the data may be included in the prompt and, as such, the content generator 250 may obtain the data, or search for the data, in accordance with the data indications provided in the prompt.

As can be appreciated, in some embodiments, the prompt may include additional or alternative data, such as output attributes or additional context. Output attributes generally indicate desired aspects associated with an output, such as generated content. For example, an output attribute may indicate a target temperature to be associated with the output. A temperature refers to a hyperparameter used to control the randomness of predictions. Generally, a low temperature makes the model more confident, while a higher temperature makes the model less confident. Stated differently, a higher temperature can result in more random output, which can be considered more creative. On the other hand, a lower temperature generally results in a more deterministic and focused output. A temperature may be a default value, a value based on user input, or a determined value. As another example, an output attribute may indicate a length of output. For example, a prompt may include an instruction for a desired number of paragraphs or sentences. As another example, a prompt may include an instruction for a maximum number of characters or a target range of characters. As another example, an output attribute may indicate a format for the response (e.g., image format). As another example, an output attribute may indicate a target language for generating the output. For example, the text data may be provided in one language, and an output attribute may indicate to generate the output in another language. Any other instructions indicating a desired output are contemplated within embodiments of the present technology.

Additional context may include any additional information that provides context to the request. Additional context may include a day/time, an indication of a brand, campaign data, a channel of communication of the campaign asset, etc. Any additional context may be provided to indicate or describe the desired content, campaign data, etc.

In some embodiments, the prompt generator 240 may be configured to select particular data, such as relevant data, to include in the prompt. As one example, relevant data may be selected to be under a maximum number of tokens required by a content generator, such as an LLM. For example, assume an LLM includes a 3,000-token limit. In such a case, text data totaling less than the 3,000-token limit may be selected. In this regard, prompts may have a size limit, thereby limiting the number of relevant data included in the prompt. As such, in some cases, using all identified relevant data may not be possible to be used as a prompt to an LLM due to size limitations of an LLM. Hence, it is necessary to select an optimal set of relevant data for feeding to the LLM for obtaining audience insights. Although generally described as using tokens (e.g., pieces of words, individual sets of letters within words, spaces between words, and/or other natural language symbols or characters), for input size, as can be appreciated, other input sizes may be used and may not necessarily be based on token sequence length, but other data size parameters, such as bytes, number of words, etc.

Accordingly, in embodiments, the prompt generator 240 may be configured to select data, such as data relevant to the query, to include in a prompt to generate content. To identify relevant data to include, any aspect or score may be used. For example, in some cases, a relevant data score may be generated and used to select relevant data. The score may represent an importance or value associated with the relevant data. Such a score may indicate an extent or measure of some aspect for assessing data to include in the prompt. For example, a score may indicate relevance to informativeness, diversity, and/or the like. In other cases, relevant data associated with a selected or particular data source may be selected. For instance, in cases in which a product is referenced in a query, a data source more factually representing the product may be identified and used to generate the prompt.

The prompt generator 240 may format the prompt in a particular form or data structure. One example of a data structure for a prompt is as follows:

```
{ Instruction to generate content
{ Query Data
{ Set of data relevant to the query to use for generating content
  { Data Source 1; Data Set A
    ...
  { Data Source N; Data Set M
```

Any number of prompts may be generated. As one example, different prompts may be generated for different content generation requests (e.g., a first prompt for a first content generation request and a second prompt for a second content generation request). As another example, different prompts may be generated for different types of data (e.g., a first prompt for a first set of relevant data and a second prompt for a second set of relevant data).

The content generator 250 is generally configured to generate content. In this regard, the content generator 250 analyzes data in the prompt and outputs a content. In this way, the content generator 250 may generate text, images, videos, combinations thereof, etc. In embodiments, the content generator 250 takes, as input, a prompt generated by the prompt generator 240. Based on the prompt, the content generator 250 can generate content, for example, associated with a campaign included or indicated in the prompt. For instance, assume a prompt includes a query associated with content generation for a campaign, or a portion thereof. In such a case, the content generator 250 identifies or generates content, such as text and/or images, based on the query data and the data identified as being relevant to the query included or referenced in the prompt.

The content generator 250 may be or include any number of AI models or technologies (e.g., generative AI models or technologies). In some embodiments, the AI model is a Large Language Model (LLM). A language model is a statistical and probabilistic tool that determines the probability of a given sequence of words occurring in a sentence (e.g., via next sentence prediction [NSP] or minimal learning machine [MLM]). In this way, it is a tool that is trained to predict the next word in a sentence. A language model is called a large language model when it is trained on an enormous amount of data. Some examples of LLMs are OPT, FLAN-T5, BART, GOOGLE's BERT, and OpenAI's GPT-2, GPT-3, and GPT-4. For instance, GPT-3, is a large language model with 175 billion parameters trained on 570 gigabytes of text. These models have capabilities ranging from writing a simple essay to generating complex computer codes-all with limited to no supervision. Accordingly, an LLM is a deep neural network that is very large (billions to hundreds of billions of parameters) and understands, processes, and produces human natural language by being trained on massive amounts of text. In embodiments, an LLM generates representations of text, acquires world knowledge, and/or develops generative capabilities.

Additionally or alternatively, the content generator 250 may be in the form of a large vision model (LVM) that can interpret and understand visual information. A visual model may be built using a deep learning technique, such as convolutional neural networks (CNNs) and/or transformer models, which are well-suited for tasks involving image recognition, classification, segmentation, object detection, etc. At a high level, a vision model processes visual data in the form of images or videos by extracting features at various levels of abstraction to understand the content. Vision models learn to recognize patterns, shapes, textures, and other visual cues that are relevant to a task. Examples of vision models include Landing AI's LandingLens and Google's Vision Transformer (ViT).

Further, the content generator 250 may be in the form of a multimodal large language model (MLLM) that can interpret and understand visual information. An MLLM generally understands and generates text while also processing and comprehending other modalities, such as images, audio, and/or video. MLLM can associate text with various forms of data, thereby enabling such models to perform tasks that require understanding and synthesis across multiple modalities. Examples of MLLMs include Open AI's GPT-4 Turbo with Vision and Open AI's Contrastive Language-Image Pre-training (CLIP).

As such, as described herein, the content generator 250, in the form of an LLM, LVM, and/or MLLM, can obtain a prompt and, using such information in the prompt, generate content(s), for instance, for a campaign. In some embodiments, the content generator(s) takes on the form of an LLM, LVM, and/or MLLM, but various other AI models can additionally or alternatively be used.

Use of LLM, LVM, and/or MLLM may depend on the format of the data to be analyzed and/or the content to be generated. As one example, prompts including only text may be processed via an LLM, and prompts including images may be processed via an LVM and/or MLLM. In some cases, text-based prompts and visual-based prompts may be generated separately such that the text-based prompts are processed by an LLM, while the visual-based prompts are processed via an LVM or MLLM. In other cases, prompts with a visual aspect may be directed to an MLLM. In this way, an MLLM may process both the text-based data and the visual-based data. Accordingly, although the content generator 250 is illustrated as a single component, any number of components may be used to create content.

The content manager 260 is generally configured to manage the generated content. In this regard, content generated via the content generator 250 may be managed and/or transmitted by the content manager 260. In some cases, in accordance with the content generator 250 generating content, the content may be stored, for example, in data store 214, for use in implementing in a campaign, performing subsequent campaign evaluations, making decisions related to the content, etc. Additionally or alternatively, content 280 may be provided to a user device or user for viewing, such as via user device 110 of FIG. 1, or another component for viewing or performing further analysis.

Further, the content manager 260 may use the content produced or output by the content generator 250 to generate or derive additional content. For instance, in some cases, the content may be aggregated with other content. For example, in identifying text content in association with a query, the text content may be combined an image content associated with a product. As another example, content may be generated for different portions or aspects of a campaign. In this regard, content may be aggregated or compiled to generate a final content.

As another example, the content manager 260 may compare different contents to one another and provide a suggestion or recommendation for a particular content to be delivered to customers. For instance, effectiveness (e.g., represented via a score or ranking) associated with multiple generated contents may be compared to one another or ranked, and the highest effective content may be recommended or suggested for use.

In some embodiments, the content manager 260 may analyze the content and initiate a new or different content generation. For instance, based on a response to a first prompt or user feedback associated with a created content, the content manager 260 may trigger the prompt generator to generate a new content with a different instruction or based on different relevant data. Determining a scope for a new or different content creation may be performed in any number of ways. In some cases, a pattern, template, or hierarchical structure may be employed to identify a subsequent set of data to use in generating content. In other cases, AI technology may be used to facilitate generation of a subsequent relevant data scope to pursue.

Content 280 may be presented, via a user interface, in any number of ways. As one example, content may be presented in association with a query, query data, a campaign identity, a target audience, a company identity, a brand identity, a score (e.g., effectiveness score), etc. In this way, a user may select to view content associated with a particular query(s). In response, the user interface may present content generated in association with a query.

As can be appreciated, any number or type of content may be generated, and embodiments described herein are not intended to limit the type of content that may be requested or produced via AI technology. Further, various implementations may be used to generate content(s) in accordance with identified relevant data. Any number of implementations may be employed in accordance with embodiments described herein.

Although the relevant data identifier 230 is generally described in relation to identifying relevant data to generate content, the relevant data identifier 230 may be used in any number of environments or systems to identify relevant data. As one example, the relevant data identifier may be implemented to identify relevant data for training AI technology, such as an LLM.

### Exemplary Implementations for Facilitating Identification of Relevant Data Using Data Embeddings

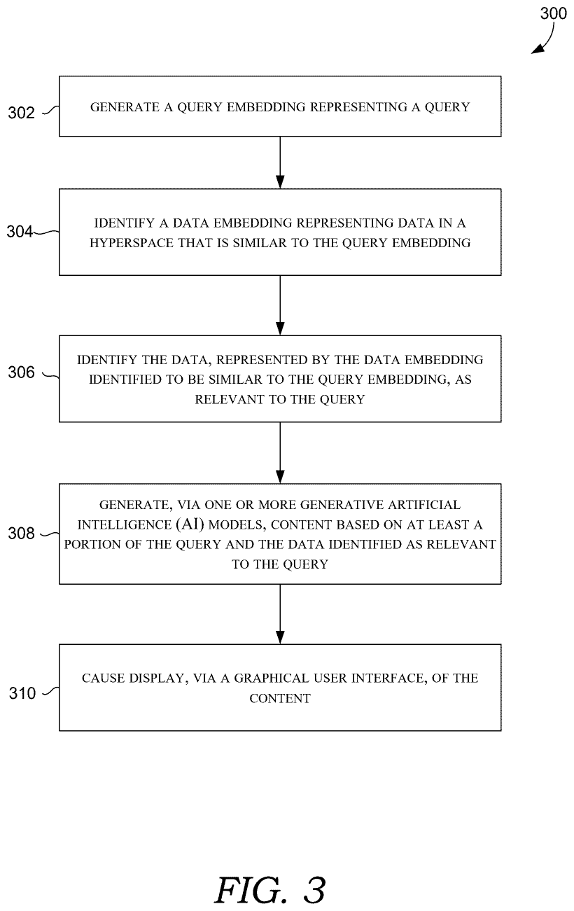

As described, various implementations can be used in accordance with embodiments described herein. FIGS. 3-5 provide methods of facilitating identification of relevant data using data embeddings, in accordance with embodiments described herein. The methods 300, 400, and 500 can be performed by a computer device, such as device 600 described below. The flow diagrams represented in FIGS. 3-5 are intended to be exemplary in nature and not limiting.

Turning initially to method 300 of FIG. 3, method 300 is directed to one implementation of facilitating identification of relevant data using data embeddings, in accordance with embodiments described herein. Initially, at block 302, a query embedding representing a query is generated. In embodiments, the query is related to a campaign and may include a goal. The query embedding may be generated using an embedding model, such as BERT, GPT, Word2Vec, etc.

At block 304, a data embedding representing data in a hyperspace that is similar to the query embedding is identified. In embodiments, the data embedding representing data in the hyperspace is identified as similar to the query embedding based on identifying a measure of similarity between the data embedding and the query embedding. In some cases, such a similarity identification may be based on the measure of similarity between the data embedding and the query embedding being greater than similarity measures associated with the other data embeddings in comparison to the query embedding.

At block 306, the data, represented by the data embedding identified to be similar to the query embedding, is identified as relevant to the query. Such data may be obtained, for example, from a data source or data store.

At block 308, content is generated via one or more AI models based on at least a portion of the query and the data identified as relevant to the query. In embodiments, such a portion of the query and the data identified as relevant to the query may be included in a prompt provided as input to the generative AI model(s).

At block 310, the content is displayed via a graphical user interface. Such content may be displayed in any number of ways and in any number of formats. In some embodiments, the content may be text, images, videos, audio, combinations thereof, etc.

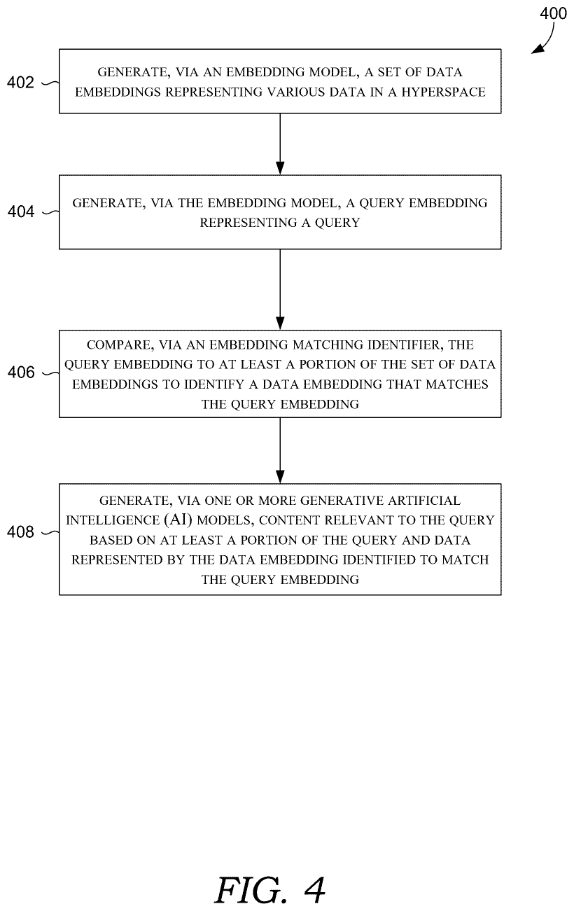

Turning to FIG. 4, method 400 of FIG. 4 is directed to another example implementation of facilitating identification of relevant data using data embeddings, in accordance with embodiments described herein. Initially, at block 402, a set of data embeddings representing various data in a hyperspace is generated. Various data may include, for example, product data, social media data, analytics data, organization data, brand data, a combination thereof, and the like.

At block 404, a query embedding representing a query is generated. Such a query embedding may be generated via an embedding model also used to generate data embeddings.

At block 406, the query embedding is compared to at least a portion of the set of data embeddings to identify a data embedding that matches the query embedding. In some cases, the data embedding is identified to match the query embedding based on a similarity score that indicates a measure of similarity between the data embedding and the query embedding.

At block 408, content relevant to the query is generated based on at least a portion of the query and data represented by the data embedding identified to match the query embedding. Content may be generated in any of a number of ways, including use of generative AI models. As one example, a prompt may be generated that includes at least a portion of the query and the data represented by the data embedding identified to match the query embedding. The prompt may be provided as input into the one or more generated AI models and, thereafter, content generated based on the prompt is obtained. In embodiments, the content may be provided to a user device for display to a user.

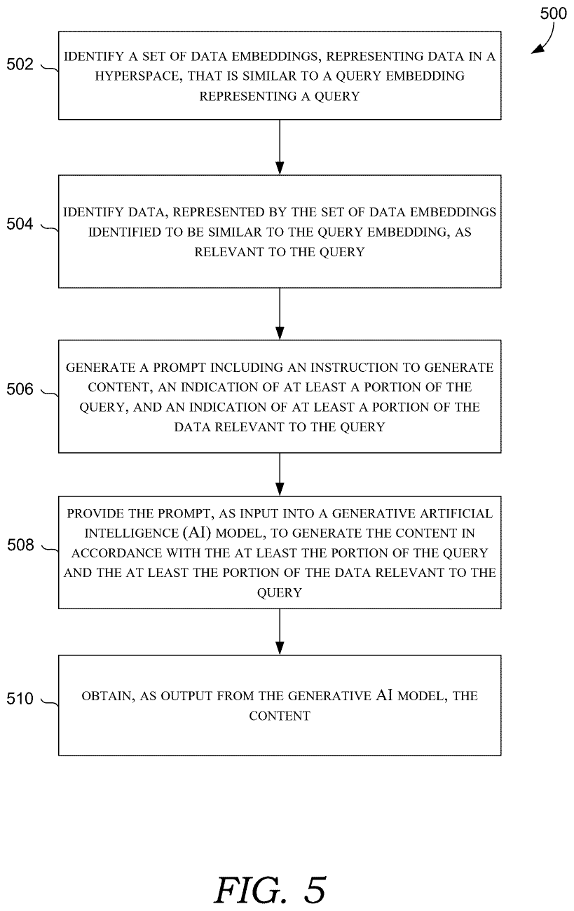

With reference now to FIG. 5, method 500 of FIG. 5 is directed to another example implementation of facilitating identification of relevant data using data embeddings, in accordance with embodiments described herein. At block 502, a set of data embeddings, representing data in a hyperspace, is identified as similar to a query embedding representing a query. In embodiments, the set of data embeddings are identified as similar to the query embedding based on similarity measures determined by comparing the set of data embeddings to the query embeddings. In some cases, a query is related to a campaign and includes an indication of a goal associated with the campaign.

At block 504, data, represented by the set of data embeddings identified to be similar to the query embedding, is identified as relevant to the query. Thereafter, at block 506, a prompt is generated that includes an instruction to generate content, an indication of at least a portion of the query, and an indication of at least a portion of the data relevant to the query.

At block 508, the prompt is provided as input into a generative artificial intelligence (AI) model to generate the content in accordance with the at least the portion of the query and the at least the portion of the data relevant to the query. Thereafter, at block 510, the content output from the generative AI model is obtained. Such content may be provided for display via a user interface.

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 6 in particular, an exemplary operating environment for implementing aspects of the technology described herein is shown and designated generally as computing device 600. Computing device 600 is just one example of a suitable computing environment and is not intended to suggest any limitation as to the scope of use or functionality of the technology described herein, and nor should the computing device 600 be interpreted as having any dependency or requirement relating to any one or combination of components illustrated.

The technology described herein may be described in the general context of computer code or machine-usable instructions, including computer-executable instructions such as program components being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 6, computing device 600 includes a bus 610 that directly or indirectly couples the following devices: memory 612, one or more processors 614, one or more presentation components 616, input/output (I/O) ports 618, I/O components 620, an illustrative power supply 622, and a radio(s) 624. Bus 610 represents what may be one or more buses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 6 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 6 and refer to “computer” or “computing device.”

Computing device 600 typically includes a variety of computer-readable media. Computer-readable media can be any available media that can be accessed by computing device 600 and includes both volatile and non-volatile, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVDs) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 612 includes computer storage media in the form of volatile and/or non-volatile memory. The memory 612 may be removable, non-removable, or a combination thereof. Exemplary memory includes solid-state memory, hard drives, and optical-disc drives. Computing device 600 includes one or more processors 614 that read data from various entities such as bus 610, memory 612, or I/O components 620. Presentation component(s) 616 present data indications to a user or other device. Exemplary presentation components 616 include a display device, speaker, printing component, and vibrating component. I/O port(s) 618 allow computing device 600 to be logically coupled to other devices including I/O components 620, some of which may be built-in.

Illustrative I/O components include a microphone, joystick, game pad, satellite dish, scanner, printer, display device, wireless device, a controller (such as a keyboard and a mouse), a natural user interface (NUI) (such as touch interaction, pen [or stylus] gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 614 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 600. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as stereoscopic camera systems, infrared camera systems, RGB camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

A computing device may include radio(s) 624. The radio 624 transmits and receives radio communications. The computing device may be a wireless terminal adapted to receive communications and media over various wireless networks. Computing device 600 may communicate via wireless protocols, such as code-division multiple access (“CDMA”), global system for mobiles (“GSM”), or time-division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive.

What is claimed is:

1. One or more computer storage media having computer-executable instructions embodied thereon that, when executed by one or more processors, cause the one or more processors to perform a method, the method comprising:
generating a query embedding representing a query;
identifying a data embedding representing data in a hyperspace that is similar to the query embedding;
identifying the data, represented by the data embedding identified to be similar to the query embedding, as relevant to the query;
generating, via one or more generative artificial intelligence (AI) models, content based on at least a portion of the query and the data identified as relevant to the query; and
causing display, via a graphical user interface, of the content.

2. The media of claim 1, wherein the query is related to a campaign and includes a goal.

3. The media of claim 1, wherein the data embedding representing data in the hyperspace is identified as similar to the query embedding based on identifying a measure of similarity between the data embedding and the query embedding.

4. The media of claim 3, wherein the measure of similarity between the data embedding and the query embedding is greater than similarity measures associated with the other data embeddings in comparison to the query embedding.

5. The media of claim 1, further comprising generating the data embedding representing the data in the hyperspace using an embedding model and storing the data embedding in a data store.

6. The media of claim 1, further comprising obtaining the data represented by the data embedding identified to be similar to the query embedding.

7. The media of claim 1, wherein the at least the portion of the query and the data identified as relevant to the query are included in a prompt provided as input to the one or more generative AI models.

8. The media of claim 1, wherein identifying a data embedding representing data in a hyperspace that is similar to the query embedding comprises searching an index of data embeddings using a search algorithm and generating a similarity score in association therewith.

9. A computer-implemented method comprising:
generating, via an embedding model, a set of data embeddings representing various data in a hyperspace;
generating, via the embedding model, a query embedding representing a query;
comparing, via an embedding matching identifier, the query embedding to at least a portion of the set of data embeddings to identify a data embedding that matches the query embedding; and
generating, via one or more generative artificial intelligence (AI) models, content relevant to the query based on at least a portion of the query and data represented by the data embedding identified to match the query embedding.

10. The method of claim 9, further comprising causing display, via a graphical user interface, of the content.

11. The method of claim 9, wherein generating the content relevant to the query comprises:
generating a prompt that includes the at least the portion of the query and the data represented by the data embedding identified to match the query embedding;
providing the prompt as input into the one or more generative AI models; and
obtaining, as output from the one or more generative AI models, content generated based on the prompt.

12. The method of claim 9, wherein the data embedding is identified to match the query embedding based on a similarity score that indicates a measure of similarity between the data embedding and the query embedding.

13. The method of claim 9, wherein the various data comprises data associated with product data, social media data, analytics data, organizational data, brand data, and/or a combination thereof.

14. The method of claim 9, wherein generation of the content is further based on at least a second data identified as relevant to the query in accordance with the comparison of the query embedding to the at least the portion of the set of data embeddings.

15. A computing system comprising:
a processor; and
one or more computer storage media storing computer-useable instructions that, when used by the one or more processors, cause the one or more processors to perform operations comprising:
identifying a set of data embeddings, representing data in a hyperspace, that is similar to a query embedding representing a query;
identifying data, represented by the set of data embeddings identified to be similar to the query embedding, as relevant to the query;
generating a prompt including an instruction to generate content, an indication of at least a portion of the query, and an indication of at least a portion of the data relevant to the query;
providing the prompt, as input into a generative artificial intelligence (AI) model, to generate the content in accordance with the at least the portion of the query and the at least the portion of the data relevant to the query; and
obtaining, as output from the generative AI model, the content.

16. The system of claim 15, wherein the operations further comprise providing, for display via a user interface, the content.

17. The system of claim 15, wherein the set of data embeddings are identified as similar to the query embedding based on similarity measures determined by comparing the set of data embeddings to the query embedding.

18. The system of claim 15, further comprising generating the set of data embeddings and the query embedding using an embedding model.

19. The system of claim 15, wherein the query is related to a campaign and includes an indication of a goal associated with the campaign.

20. The system of claim 15, further comprising obtaining the data represented by the set of data embeddings identified to be similar to the query embedding.
